(19) United States
(12) Patent Application Publication
(10) Pub. No.: US 2009/0236199 A1
(43) Pub. Date: Sep. 24, 2009

(54) Coin change device with automatic readjustmentment and classification

(76) Inventor: Shao-Tsu Cheng, Hsin-Chuang City (TW)

Correspondence Address: TROXELL LAW OFFICE PLLC, 5205 LEESBURG PIKE, SUITE 1404, FALLS CHURCH, VA, 22041, US

(21) Appl. No.: 12/076,606

(22) Filed: Mar. 20, 2008

(51) Int. Cl. G07F 9/08

(52) U.S. Cl. 194/215

(57) ABSTRACT

A coin change device with automatic readjustment and classification to match with the transaction/retail (wholesale) account closing device such as a cash register for use comprises a coin readjustment and dispense module, a recognition module, a storage module, and a dispense/retrieve module, wherein more than one coin can be thrown in said coin readjustment and dispense module at one time to perform automatic coin recognition, calculation, storage and change-making action through said coin change device with automatic readjustment and classification, thereby to exempt required manual counting and change-making operation by the register and thus reducing chances of possible errors in receiving and dispensing the monetary amount as well as saving the time required for daily coins counting and adjustment.

### BACKGROUND OF THE INVENTION

(a) Field of the Invention

The invention is related to a coin change device with automatic readjustment and classification which can perform automatic functions of readjustment, recognition, calculation and storage as well as change-making action, and is more particularly suitable for settling accounts in various transaction/retail (wholesale) businesses.

(b) Description of the Prior Art

Referring to FIG. 1 which is a schematic view of a conventional cash register, as shown in the Fig., the conventional cash register 90 is constituted by structural members such as a screen 91, a keyboard 92 and a change box 93, wherein screen 91 is used for displaying amount of payment and change, and change box 93 is used for storing paper bills and coins, thereby when the register receives the paper bills and coins of payment from the customer, the cash amount is first counted, then paper bills and coins are respectively put in the change box, and in case of change-making is required, the amount of change money is taken out from the change box and given to the consumer.

The above said account setting actions are manually handled by the register, therefore, errors may happen in calculating the received cash amount or change-making deals to require for counting coins in daily account closure, while it is labor consuming and may cause other chances of errors.

### SUMMARY OF THE INVENTION

To present a clearer picture of the characteristics and advantageous arts of the invention, a coin change device with automatic readjustment and classification capable of performing automatic coin recognition, calculation, storage and change-making action, etc. is used as the preferred embodiment for detail description.

The invention discloses a coin change device with automatic readjustment and classification to resolve the know problem of possible calculation errors in receiving and dispensing coins and to resolve the problem of manpower loss for having to separately count the coins.

Another embodiment of the invention is disclosed by that said coin change device with automatic readjustment and classification can be matched with transaction/retail(wholesale) account closing device for use to comprise a coin readjustment and dispense module, a recognition module, a storage module and a dispense/retrieve module, wherein more than one, even several tens of coins can be thrown into said coin readjustment and dispense module at one time to recognize coin value and authenticity by said recognition module, and said storage module is subsequently installed rear to the recognition module for storing coins to finally through said dispense/retrieve module to dispense the coin changes or to further retrieve the coins back to the coin box.

Therefore, the invention is purposed to disclose a coin change device with automatic readjustment and classification, wherein when the customer makes payment to the register, all the coins received by the register are thrown into the coin readjustment and dispense module, therefrom said coins are automatically, individually and orderly performed with recognition, calculation, storage and change-making actions, thereby to exempt required manual counting and change-making operation by the register and thus reducing chances of possible errors in receiving and dispensing the monetary amount as well as saving the time required for daily coins counting and adjustment.

### BRIEF DESCRIPTION OF THE DRAWINGS

FIG. 1 is a schematic view of a conventional cash register

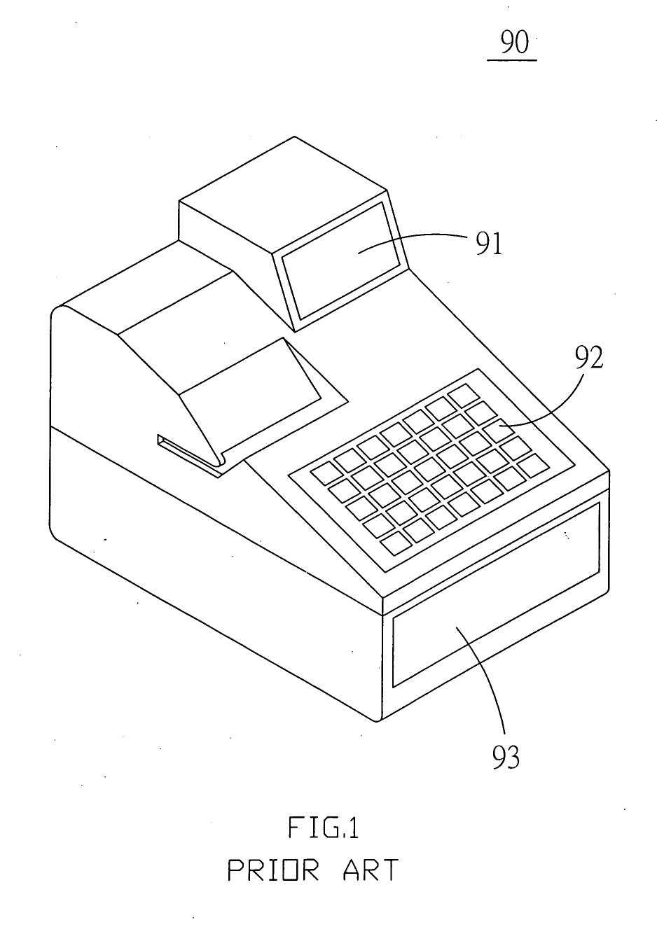

FIG. 2(A) is a schematic view showing the first embodiment of the invented coin change device with automatic readjustment and classification.

FIG. 2(B) is a schematic view showing the second embodiment of the invented coin change device with automatic readjustment and classification.

FIG. 3 is a schematic view showing the third embodiment of the invented coin change device with automatic readjustment and classification.

FIG. 4(A) is a schematic view showing the fourth embodiment of the invented coin change device with automatic readjustment and classification.

FIG. 4(B) is a schematic view showing the fifth embodiment of the invented coin change device with automatic readjustment and classification.

FIG. 5 is a perspective view showing a coin readjustment and dispense module of the invention.

FIG. 6 is a schematic view showing the action of a coin readjustment and dispense module of the invention.

FIG. 7 shows a status of the invented coin change device with automatic readjustment and classification in usage.

### DETAIL DESCRIPTION OF THE PREFERRED EMBODIMENTS

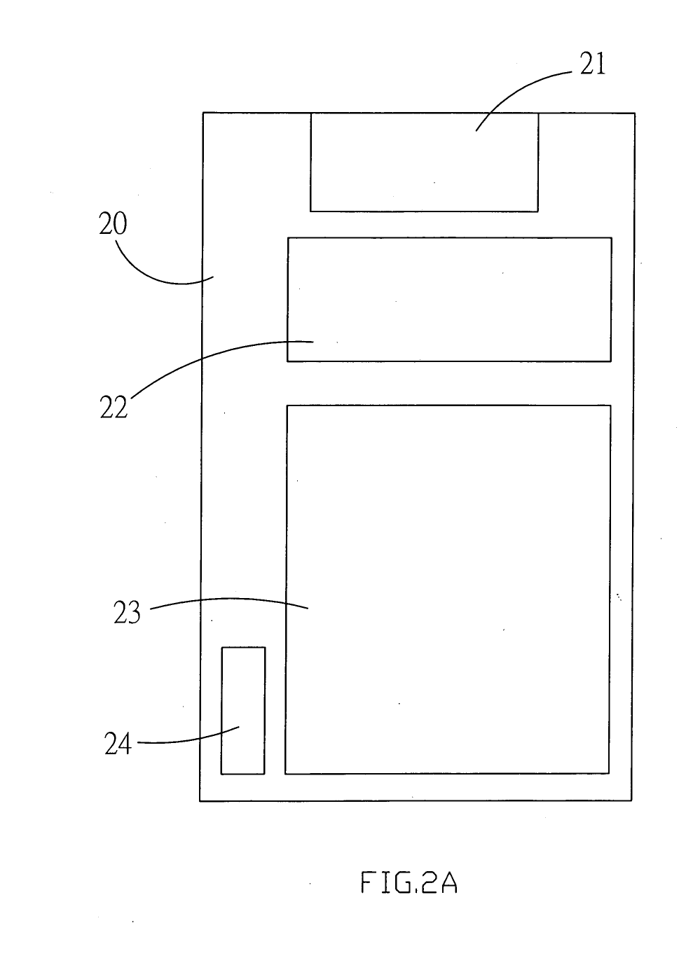

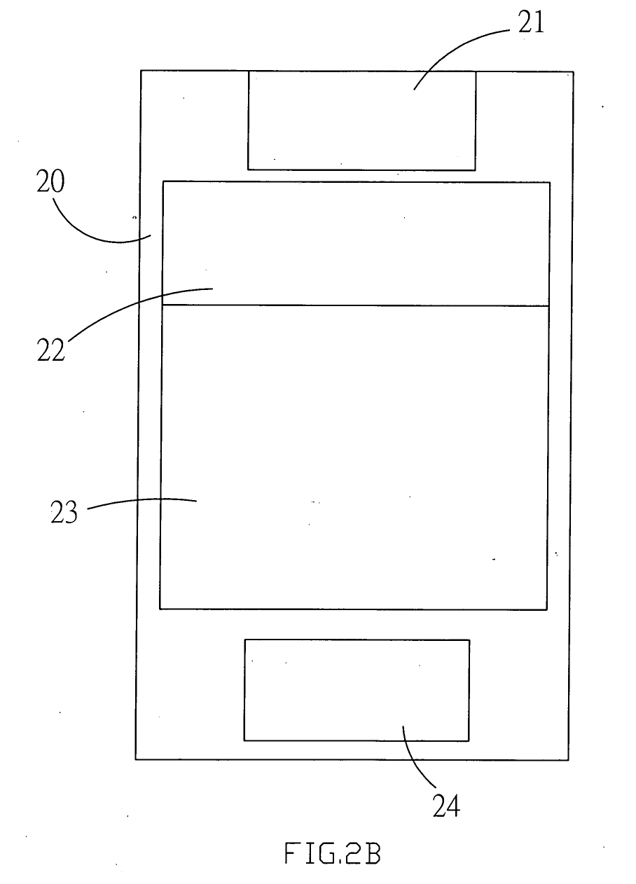

Referring to FIG. 2(A) which is a schematic view showing the first embodiment of the invented coin change device with automatic readjustment and classification, wherein as shown in the Fig., said coin change device with automatic readjustment and classification 20 comprises a coin readjustment and dispense module 21, recognition module 22, storage module 23 and dispense/retrieve module 24, wherein more than one, even several tens of coins can be thrown into the coin readjustment and dispense module 21 at one time, the recognition module 22 is installed rear to said coin readjustment and dispense module 21 to recognize the coin value and authenticity (not shown in the Fig.), the storage module 23 is subsequently further installed rear to said recognition module 22 for coins storage, and lastly the dispense/retrieve module 24 is sidely installed at the rear end of said coin change device with automatic readjustment and classification 20, whereby to dispense the coin changes and to take out the coins conveniently, or said dispense/retrieve module 24 can be frontly installed at rear end of said coin change device with automatic readjustment and classification 20 as shown in FIG. 2(B) which is a schematic view of the second embodiment.

As said above, when the customer makes payment to the register, all the coins received by the register are thrown into the coin readjustment and dispense module 21, therefrom said coins are automatically, individually and orderly passed through the recognition module 22 for recognizing the coin values and authenticities thereof, further counted and subsequently dropped into the storage module 23 for storage. In case there is a need for change-making after counting, the coin changes are automatically dispensed by dispense/retrieve module 24 to allow the register to directly take out the coin changes from said dispense/retrieve module 24 and return to the consumer without having to open said storage module 23 for the changes. Through this, coin recognition, counting, storage and change-making action can be automatically performed by said coin change device with automatic readjustment and classification 20, thereby to exempt required manual counting and change-making operation by the register and thus reducing chances of possible errors in receiving and dispensing the monetary amount as well as saving the time required for daily coins counting and adjustment.

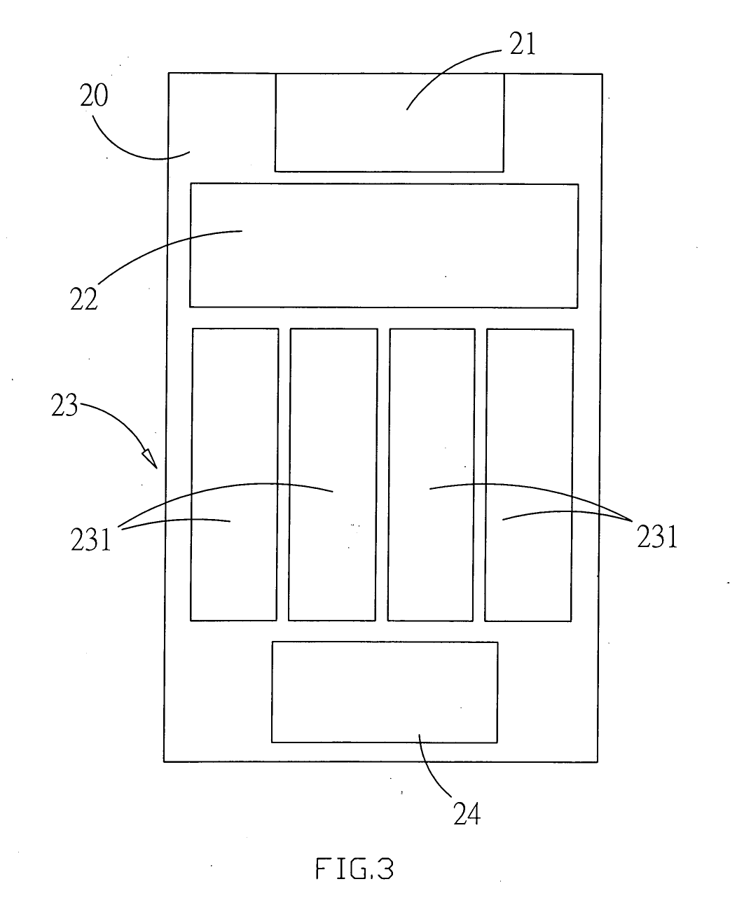

Other embodiments of the invention can be further described more clearly by referring to the following Figs., it is first referred to FIG. 3 which is a schematic view showing the third embodiment of the invented coin change device with automatic readjustment and classification, wherein storage module 23 comprises a plurality of storage boxes 231, such as that four storage boxes 231 are installed in parallel rear to said recognition module 22 for storing different values of recognized coins including such as coins of 1, 5, 10 and 50 NTD values, whereby said four storage boxes 231 can be respectively used for supplementing or counting coins and if said storage module 23 is damaged, it can be independently repaired, and that is simpler and more convenient.

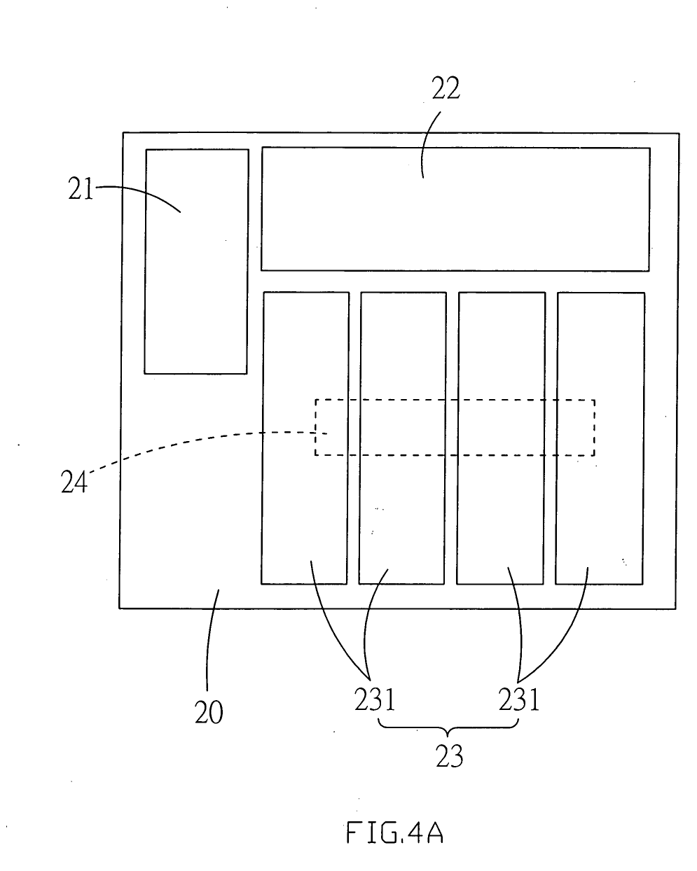

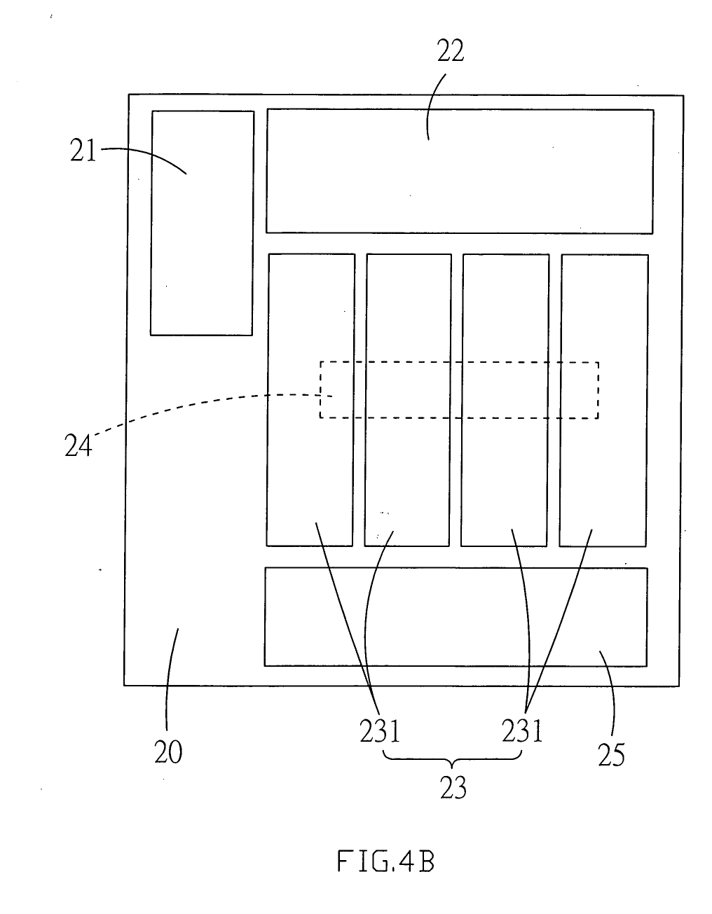

Further referring to FIG. 4(A) which is a schematic view showing the fourth embodiment of the invented coin change device with automatic readjustment and classification by taking account of human engineering factors in the embodiment thereof, wherein said coin readjustment and dispense module 21 is moved to one side of said coin change device with automatic readjustment and classification 20 for the consumer or register to throw in coins conveniently, while said dispense/retrieve module 24 is located at the middle of said integral coin change device with automatic readjustment and classification 20 approximately facing to above waist of the register so as to allow the register to take out the coin changes and quickly return to the consumer.

Further, as shown in FIG. 4(B), a coin buffer storage module 25 can be installed rear to said storage module 23, whereby when the thrown-in coins are incompatible with said storage module 23 (such as a 20 NTD coin is thrown in, but no storage module 23 for the 20 NTD coin is available), then the incompatible coin is dropped to said coin buffer storage module, or when said coin storage module 23 is full to store no more coins, said coins are dropped to said coin buffer storage module 25 for temporary storage.

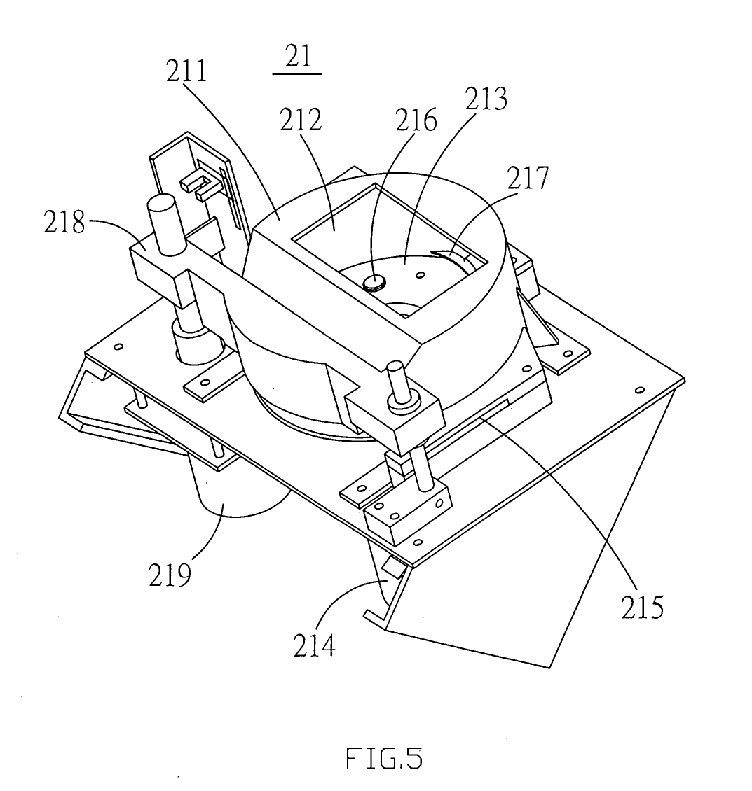

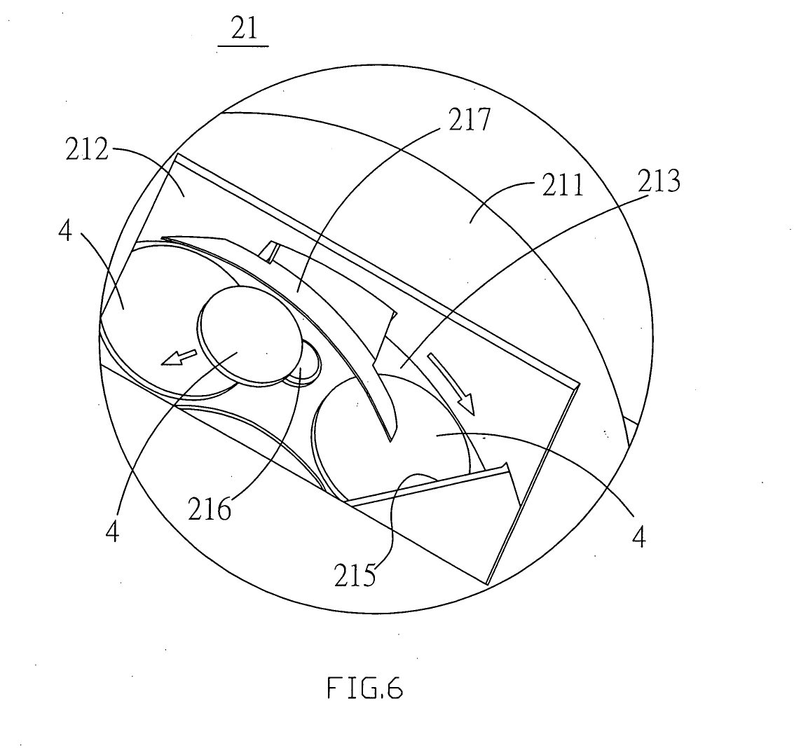

Practical implementations are as shown in FIG. 5, wherein said coin readjustment and dispense module 21 comprises a main body 211, a throw-in opening 212, a rotating disk 213, a first driving device 214 and a disk outlet 215, wherein said main body 211 is made with a said throw-in opening 212 on the top thereof, said rotating disk 213 being installed under throw-in opening 212 has several raised posts 216 thereon and a poke piece 217 at one side thereof, said first driving device 214 is inter-connected with said rotating disk 213 whereby to drive it for rotation, and said disk outlet 215 is installed at another side of said main body 211 relative to said throw-in opening 212. Referring to FIG. 6 simultaneously, when a handful of coins 4 is thrown in, said coins 4 are dropped on said rotating disk 213 between said raised posts 216 whereof, whereby when said rotating disk 213 is driven by said first driving device 214 to rotate, said coins 4 are driven to move towards said disk outlet 215, and at the same time, other coins 4 on top of coins 4 piled up between raised posts 216 are poked away by poke piece 217 to allow said coins 4 between raised posts 216 via disk outlet 215 to smoothly fall in said recognition module 22 for recognizing coin value and authenticity.

A foreign object discharge cassette 218 is further sidely installed on main body 211 of said coin readjustment and dispense module 21 to be driven upward and downward by a second driving device 219 for opening and closing actions, in case that foreign objects other than coins are mistakenly thrown in the coin chute, said second driving device 219 is actuated to open the foreign object discharge cassette 218 to discharge the foreign objects.

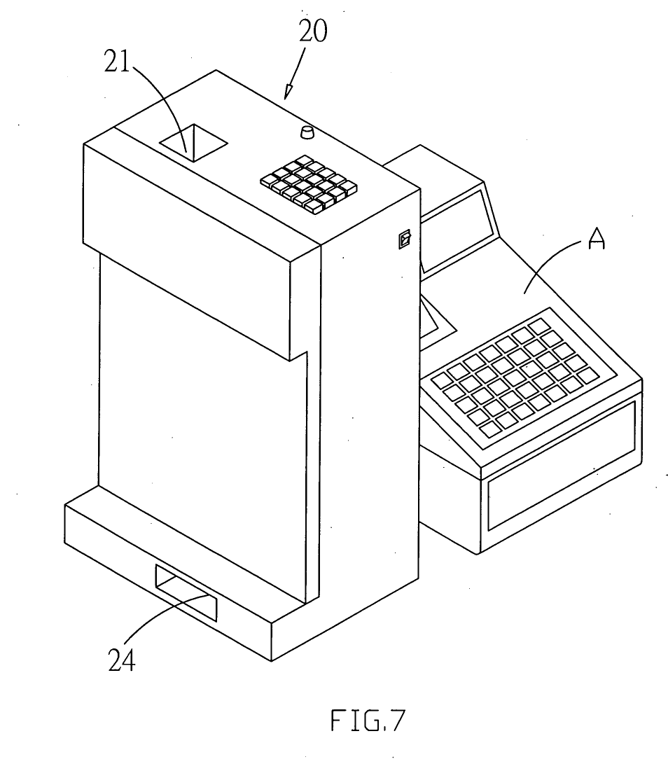

In addition, said coin change device with automatic readjustment and classification 20 can be further matched with various sales device A for use as shown in FIG. 7 which gives an embodiment of a transaction/retail (wholesale) account closing device A combining with a cash register, wherein said coin change device with automatic readjustment and classification 20 is externally attached to one side of the sales device A, or said coin change device with automatic readjustment and classification 20 can be combined into the transaction/retail(wholesale) account closing device A for a good appearance effect.

For said reason, most importantly the receiving and dispensing coins operation can be automatically performed by the register through the coin change device with automatic readjustment and classification of the invention. Therefore, the invention is full of originality and progressiveness to meet the requirements for patent applications. Hence, it is herein applied according to law and your earlier approval on the claims is greatly appreciated.

The invention has been specifically described hereinbefore, wherein only preferred embodiments of the invention are described, and scope of the invention shall not be limited thereto. All equivalent changes or modifications thereof relative to claims of the invention shall be included in the claimed scope of the invention.

I claim,

1. A coin change device with automatic readjustment and classification comprises:
A coin readjustment and dispense module to allow for throwing in one or more than one coins at one time;
A recognition module is installed rear to said coin readjustment and dispense module for recognizing coin value and authenticity;
A storage module is installed rear to said recognition module for coin storage; and
A dispense/retrieve module is installed to rear end of said coin collection and adjustment device for dispensing coins.

2. The coin change device with automatic readjustment and classification as claimed in claim 1, wherein said storage module includes a plurality of storage boxes installed in parallel rear to said recognition module for storing coins of different values.

3. The coin change device with automatic readjustment and classification as claimed in claim 1, wherein said coin readjustment and dispense module is sidely located rear to the coin collection and adjustment device.

4. The coin change device with automatic readjustment and classification as claimed in claim 1, wherein said dispense/retrieve module is located at middle of said coin change device with automatic readjustment and classification.

5. The coin change device with automatic readjustment and classification as claimed in claim 1, wherein it further includes a coin buffer storage module which is installed rear to said storage module.

6. The coin change device with automatic readjustment and classification as claimed in claim 1, wherein said coin readjustment and dispense module comprises at least the following:
A main body;
A throw-in opening is installed at tope of the main body for throwing in coins;
A rotating disk being installed under said throw-in opening has several raised posts and a poke piece at one side thereof;
A first driving device is inter-connected with a rotating disk to drive it for rotation; and
A disk outlet is installed on the main body relative to one side of throw-in opening.

7. The coin change device with automatic readjustment and classification as claimed in claim 6, wherein a foreign object discharge cassette is further sidely installed on main body of said coin readjustment and dispense module to be driven upward and downward by a second driving device for opening and closing actions.
